(19) United States
(12) Patent Application Publication
(10) Pub. No.: US 2004/0036960 A1
(43) Pub. Date: Feb. 26, 2004

(54) Method and apparatus for optical amplifcation with spontaneous emission cancellation

(76) Inventor: Mani Ramachandran, San Jose, CA (US)

Correspondence Address: Jack J'maev, SUITE 110, 11800 CENTRAL AVE, CHINO, CA, 91710, US

(21) Appl. No.: 10/227,495

(22) Filed: Aug. 24, 2002

(51) Int. Cl. H04B 10/12

(52) U.S. Cl. 359/341.41

(57) ABSTRACT

Optical amplifier system controls gain with wide dynamic range by essentially eliminating amplified spontaneous emission components from amplifier feedback signal. Spontaneous emissions power level may be estimated as a constant, estimated based on energy imparted to the amplifier or measured and then subtracted from output power signal.

### FIELD OF THE INVENTION

This invention relates generally to fiber optic communications; and specifically to optical amplifiers for link and fiber loss compensation.

### BACKGROUND OF THE INVENTION

Modern wave division multiplexing optical communications systems provide increased information carrying capacity by simultaneously transmitting multiple information carrying optical signals over the same optical fiber. In a wave division multiplexing (WDM) system, multiple data-modulated optical signals can be carried on multiple optical channels in a single fiber. Each optical channel is characterized by a channel wavelength. The channel wavelength is the wavelength of the light that is modulated by the data carried by the channel.

A plurality of modulated optical signals having different optical carrier wavelengths may be simultaneously transmitted through a fiber. Each optical signal is said to be transmitted on a respective optical channel at a different wavelength. The optical signals on the different optical channels may be optically combined so that they may be conveyed by a single optical fiber. Subsequently, the individual optical signals on the different individual optical channels can then be segregated so that each individual optical signal can be routed to its designated receiver. By transmitting different data-modulated optical signals on different optical channels, the capacity of a single fiber to carry data is proportionally enhanced.

In order to be useful, WDM systems route fiber optic pathways from one location to another. The physical routing typically requires splicing of one length of fiber optic cable to another. This is accomplished by attaching connectors at each end of each segment of cable and then mechanically coupling the connectors together. In some situations, optical energy may be siphoned off of the main optical pathway in order to convey an optical signal to a multiplicity of physical locations and/or direct the various optical signals to their respective receivers. Consequently, the optical signals carried by the optical fiber may be attenuated. These types of attenuations are known as fiber link and splitting losses. The fiber itself may also attenuate the strength of an optical signal because it may not be entirely effective in conveying optical energy. This results in fiber cable loss. After some modest distance, accumulated fiber link, splitting and cable losses may degrade the strength of an optical signal carried by the fiber to such an extent that it may not be properly detected at the receiving end of a communications path.

Optical amplifiers may be used in WDM systems to compensate for fiber link, splitting and fiber losses. Optical amplifiers are typically constructed using rare-earth “doped” optical fibers. Some optical amplifiers use rare-earth materials such as Erbium or Erbium Ytterbium. These types of fiber optical amplifiers are known as Erbium (or Erbium Ytterbium) doped fiber amplifiers (EDFAs). As a result of the doping process, the optical fiber that comprises the EDFA becomes seeded with Erbium ions. When an optical signal enters this segment of optical fiber, it stimulates the Erbium ions resulting in the emission of light. Amplification occurs when even more energy is imparted to the Erbium ion doped fiber segment. This additional energy, which may be in the form of light, also stimulates emission and results in amplification of the original optical signal. Additional light may be imparted to the optical segment comprising the EDFA using some light source. This additional light source is said to “pump” the amplifier and is hence referred to as a “pump” source. A laser may also be used to pump an EDFA. EDFAs and other types of fiber optic amplifiers have been used successfully to amplify optical signals conveyed by an optical fiber. This amplification may compensate for fiber link, splitting, cable and other miscellaneous losses. The amount of amplification, or “gain” that must be provided by any particular EDFA may need to be controlled to ensure that the optical signal is faithfully propagated by a WDM fiber optic system. One way of controlling the amount of amplification is to control the amount of additional light that is pumped into the fiber optic segment comprising an EDFA.

Controlling any amplifier typically depends on closed-loop feedback principals. The gain of an optical amplifier can be controlled by comparing the output of the amplifier with the input of the optical signal entering the input of the amplifier and then controlling the amount of energy that is imparted to the EDFA. The control function typically maintains the output power of the amplifier at a constant multiple of the input power; again, closed-loop feedback control.

Just like any other amplifier, optical amplifiers exhibit random noise. In optical amplifiers like EDFAs, noise is manifest through spontaneous emissions of light. As the optical amplifier is excited with additional energy, these spontaneous emissions are also amplified. This noise component is typically referred to as amplified spontaneous emission (ASE).

The output of an operating EDFA typically represents not only an amplified optical signal, but also contains an ASE noise component generated by the amplifier itself. In many cases, the amount of ASE noise may be very great. Depending on the power level of the input optical signal and on the gain of the optical amplifier, ASE noise may actually approach or be greater than the power of the amplified optical signal.

An amplifier control circuit typically detects the amount of optical power that is emitted by the output of an EDFA and uses this as one input to the control function that it implements. In order to detect this power level, a measurement portion of the optical energy output from the EDFA may be siphoned off of a main output pathway and directed to a detector. The detector may then convert the measurement portion of energy into an “output power” signal that may be used by the control circuit. This output power signal has traditionally been used as an amplifier “feedback” signal that enables the control circuit to maintain a constant amplifier gain as the power of the input optical signal fluctuates.

When the amount of ASE noise in the output rivals the power level of the amplified optical signal, the control circuitry may become saturated by the output power signal. This is due to the fact that the ASE component of the output power signal can drive the control circuitry out of a particular operating range that it may have been designed to operate in. When this happens, the optical amplifier may operate in a non-linear manner and may exhibit other undesirable characteristics.

In the case where an optical amplifier is designed to operate in a particular range, it may be expected that the amount of optical signal power input to the EDFA and the gain of the amplifier will remain essentially constant. The amount of ASE that may be expected at that input signal power and amplifier gain can be anticipated and the control circuitry can be designed to accommodate even high levels of ASE without causing the output power detection circuitry to saturate.

Where an optical amplifier must operate over a wide range of input power and gain levels, the amount of ASE relative to the power level of an amplified optical signal emitted by an EDFA may vary widely. In such a case, it may be impractical to design a control circuit that can provide enough variation in control range. The capacity to control an amplifier over a wide operating range is typically referred to as the “dynamic range” of the control function. And where enough dynamic range can be provided, the overall quality of the control function will definitely be impaired because only a portion of the dynamic range of the detection circuitry may be used to affect amplifier gain control. The remaining portion of the dynamic range must be dedicated to accommodation of the ASE noise component that is present in the output of the EDFA, i.e. the feedback signal.

One place where it is important for an optical amplifier to function over a wide range of operating points is the application of an EDFA or other optical amplifier in a WDM based communications system. In such systems, various optical signals at different wavelengths may arrive collectively at an optical amplifier. The problem is that most optical amplifiers do not amplify light equally as the wavelength of the light is changed. Hence, an optical signal at one wavelength may experience more or less gain than an optical signal at another wavelength for the same feedback signal. As a result, an optical amplifier used to boost signal levels in a WDM communications system must be capable of operating over a wide operating range. In order to do this effectively, the dynamic range of an amplifier control circuit needs to be dedicated to control of the amplifier at a particular wavelength rather than to accommodation of an ASE or other noise component in the control feedback signal.

### SUMMARY OF THE INVENTION

The present invention comprises a method for controlling an optical amplifier that enhances the amount of dynamic range available for amplifier control in the presence of amplified spontaneous emissions (ASE). According to one illustrative method of the present invention, the amount of ASE power that is emitted by an optical amplifier may be substantially eliminated from the amplifier control feedback signal. Such an amplifier control feedback signal is typically derived by sensing the output power of the optical amplifier.

Accordingly, one illustrative method of the present invention provides for determining the power level of an optical signal. The optical signal is then directed to an optical amplifier. As the amplifier operates, it will amplify the input optical signal according to the amount of energy that it may receive. In one example, energy is received from a light source. As the amplifier operates, it tends to generate noise in the form of amplified spontaneous emissions. These amplified spontaneous emissions emanate from the input and output of the optical amplifier.

The output of the optical amplifier has at least two components: an amplified rendition of the optical signal and amplified spontaneous emissions. The present method determines the total power emanating from the optical amplifier and then subtracts a representative power level for the amplified spontaneous emissions. This results in the creation of a feedback signal that is essentially free of any ASE noise component. The optical amplifier may then be controlled by driving the amplifier with an amount of energy according to the feedback signal and a reference signal. The reference signal is usually the power level of the input optical signal. This forms a closed-feedback control loop.

According to one variation of the inventive method taught here, determining the power level of the input optical signal may be accomplished by siphoning off a measurement portion of the optical signal and then generating a signal indicative of that measurement portion. Likewise, determining the power level of the output of the optical amplifier may be accomplished by segregating a measurement portion of the optical energy emanating from the optical amplifier and then generating a signal indicative of the power level of that measurement portion.

Several methods are taught for determining the power level of the amplified spontaneous emissions generated by the amplifier. According to one derivative method, a constant value may be used to represent the amount of spontaneous emissions generated by the optical amplifier. According to one derivative method, a function may be used to determine the amplified spontaneous emissions generated by the optical amplifier. Various independent variables can be used when consulting the function including, but not limited to the amount of energy delivered to the optical amplifier and the operating temperature of the optical amplifier.

Yet another derivative method is taught wherein the amount of amplified spontaneous emissions emanating from an input of the optical amplifier may be measured and used in the compensation process hereto described. According to this derivative method, some or all of the energy emanating from the input of the optical amplifier may be segregated and used to generate a signal representative of the spontaneous emissions generated by the optical amplifier.

The present invention also comprises an optical amplifier system that embodies the illustrative method of the present invention. Accordingly, one example optical amplifier system may comprise an input power detector. This may be used to generate an input power signal according to the power level of the optical signal to be amplified. An optical amplifier is then used to amplify the optical signal. Optical amplifier gain can be controlled by varying the amount of energy that the system imparts to the amplifier. In one example embodiment, a light source may be used to impart energy to the optical amplifier.

A spontaneous emissions determination unit generates a signal representative of the amount of amplified spontaneous emissions that the optical amplifier generates as it operates. A first differencing unit generates an amplifier feedback signal by subtracting the signal representative of amplified spontaneous emissions from a total output power signal generated by an output power detector. According to some example embodiments of present invention, the first differencing unit may be an instrumentation amplifier. A second differencing unit generates a control signal that is used to control the amount of energy delivered to the optical amplifier. Closed-loop feedback is used in order to reduce the difference between the amplifier feedback signal and the input power signal.

According to one example embodiment of the present invention, the input power detector is an optical coupler that segregates a measurement portion of the optical signal. The output of the optical coupler is then directed to a detector that typically converts the measurement portion of the input optical signal into a signal. In a like manner, the output power detector also has an optical coupler for segregating a measurement portion of the optical power emanating from the output of the optical amplifier. This measurement portion of the output power is then directed to a detector resulting in a signal representative of the total output power emanating from the optical amplifier.

According to one alternative embodiment of the present invention, the spontaneous emissions determination unit may comprise a reference that generates an essentially constant signal. This typically represents the power level of the amplified spontaneous emissions that may be generated by the optical amplifier. In yet another alternative embodiment of the present invention, the spontaneous emissions determination unit generates an amplified spontaneous emissions signal according to an input signal. The input signal may reflect, among other things, the amount of energy delivered to the optical amplifier or the temperature at which the amplifier is operating. These are but two examples of operating parameters that may affect the amount of ASE generated by a particular optical amplifier.

The spontaneous emissions determination unit can also be formed from a reference table, an indexing unit and a signal generator. According to this alternative embodiment of the invention, the reference table provides a reference value that can be used to drive the signal generator. In order to obtain the reference value, the indexing unit typically generates an index for the reference table. An analog-to-digital converter can be used to generate an index according to an input signal and a digital-to-analog converter generates a signal according to the digital value received from the reference table. The input signal may represent operating parameters such as, but not limited to the amount of energy delivered to the optical amplifier and operating temperature.

According to one additional alternative embodiment that illustrates one feature of the present invention, an optical amplifier system may have a spontaneous emissions detector. An optical coupler segregates spontaneous emissions emanating from an input of the optical amplifier. This energy is then converted into a signal by a detector. This signal may then be provided to the first differencing unit by the spontaneous emissions determination unit.

Digital gain control may also be used to control the operation of an optical amplifier. According to one alternative embodiment, the input power detector may be augmented by a first digitizing unit. The first digitizing unit typically generates a stream of digital values according to the input power signal generated by the input power detector. Total output power, as detected by the output power detector, is converted into a stream of digital values by a second digitizing unit. According to at least one alternative embodiment, an optical amplifier system comprising digital gain control may have a spontaneous emissions detector that detects the power of amplified spontaneous emissions emanating from an input of the optical amplifier. The spontaneous emissions detector is augmented by a third digitizing unit. The output of the third digitizing unit is a stream of digital values representing amplified spontaneous emissions.

A processing unit provides an execution unit for executing instruction sequences and a program memory. Further embodying the invention are a spontaneous emissions determination instruction sequence, a spontaneous emissions cancellation instruction sequence and a sampled control-loop instruction sequence; any or all of which may be stored in the program memory.

The execution unit begins by executing the spontaneous emissions cancellation instruction sequence. This minimally causes the execution unit to receive a stream of digital values representative of the total output power emanating from the optical amplifier. The spontaneous emissions cancellation instruction sequence then causes the execution unit to execute the spontaneous emissions determination instruction sequence. The spontaneous emissions determination instruction sequence typically returns a value for amplified spontaneous emissions. The spontaneous emissions cancellation instruction sequence then causes the execution unit to generate a feedback stream by subtracting the value of the amplified spontaneous emissions from corresponding digital values in the stream of digital values representative of total output power emanating from the optical amplifier. The spontaneous emissions determination instruction sequence may return a constant value indicative of the amount of amplified spontaneous emissions generated by the optical amplifier. According to yet a different illustrative embodiment of the present invention, the spontaneous emissions determination instruction sequence may return a value for amplified spontaneous emissions by consulting a function using an independent variable. The function may also be stored as a table and indexed by a digital value reflecting an independent variable. Different independent variables can be used to drive the function. These include, but should not be limited to, the amount of energy imparted to the optical amplifier and the amplifier's operating temperature. Some operating parameters, such as the amount of energy imparted to the optical amplifier, are available in the digital domain, i.e. a control stream of digital values as described below.

The execution unit, according to this alternative embodiment of the invention, then executes the sampled control-loop instruction sequence. The sampled control-loop instruction sequence minimally causes the processor to receive the feedback stream generated by the processor when executing the spontaneous emissions cancellation instruction sequence. Using well-known, sampled control theory techniques, the execution unit typically uses the stream of digital values representative of input power as a reference when processing the feedback stream in order to generate a control stream of digital values for controlling the amount of energy delivered to the optical amplifier.

A digital-to-analog converter typically receives the control stream of digital values and converts this into an analog signal that may be used to control an energy source; in one example a light source that imparts optical energy to the optical amplifier can be used.

### BRIEF DESCRIPTION OF THE DRAWINGS

The present invention will hereinafter be described in conjunction with the appended drawings figures, wherein like numerals denote like elements, and:

FIG. 1 is a flow diagram that depicts one illustrative method for controlling an optical amplifier with a feedback signal substantially devoid of spontaneous emission noise components;

FIG. 2 is a flow diagram that illustrates further possible steps comprising a method for controlling an optical amplifier according to the present invention;

FIG. 3 is a flow diagram that depicts one possible method for determining the power of an amplified input signal in the output of an optical amplifier according to the present invention;

FIG. 4 is a block diagram that depicts one example structure of an optical amplifier system comprising spontaneous emissions cancellation according to the present invention;

FIG. 5 is a block diagram of one possible alternative structure of a spontaneous emissions determiner that may be used to generate a spontaneous amplifier emissions signal according to the present invention;

FIG. 6 is a block diagram of an illustrative optical amplifier system according to the present invention that is digitally controlled; and

FIG. 7 is a block diagram of one example structure of an optical amplifier system comprising digital control and an analog spontaneous emissions cancellation circuit according to the present invention.

### DETAILED DESCRIPTION OF THE INVENTION

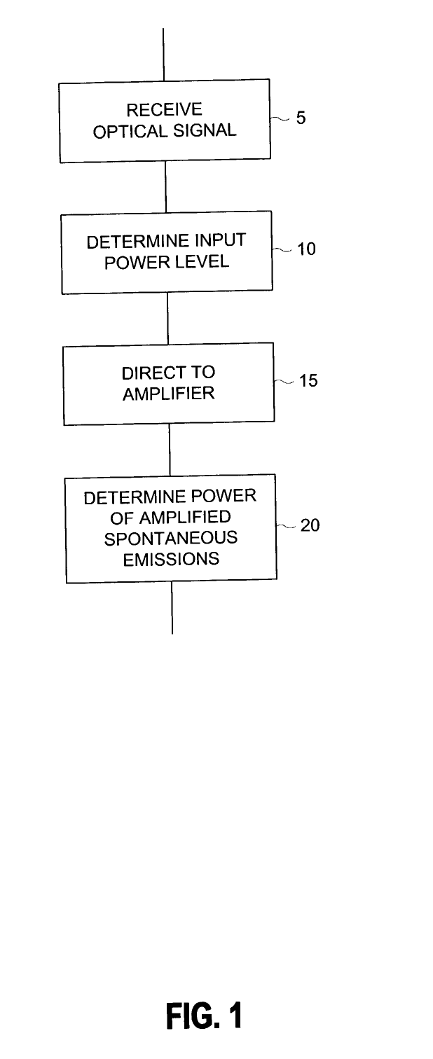

FIG. 1 is a flow diagram that depicts one illustrative method for controlling an optical amplifier with a feedback signal substantially devoid of spontaneous emission noise components. According to this illustrative method, an optical signal may first be received in an amplification system (step 5). As the optical signal arrives in the amplification system, its power level may need to be determined (step 10). Typically, the power level of the input optical signal is used as one input to a control function tailored to maintain constant gain through an amplifier.

Once the amplifier system receives the input optical signal, it may be directed to an actual optical amplifier (step 15). According to this example method of the present invention, the amount of power emanating from the optical amplifier attributable to spontaneous emissions may be also determined (step 20). Determining the power of amplified spontaneous emissions may be accomplished in a variety of manners as described below.

As the optical signal enters the actual optical amplifier, it is subject to amplification. Typically, an optical amplifier may comprise a segment of optical fiber that has been seeded with optically emissive ions. This inventive method may be applied in one instance to optical amplifiers such as rare-earth doped fibers. One example of an optical amplifier that may be controlled according to the method of the present invention is an Erbium (or Erbium Ytterbium) doped fiber amplifier commonly referred to as an “EDFA”. It should be noted that the method of the present invention should not be limited in application to the control of any one type of optical amplifier.

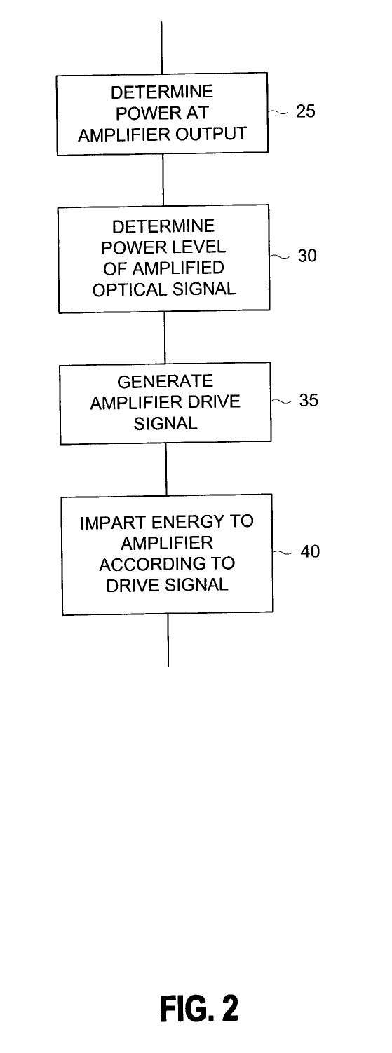

FIG. 2 is a flow diagram that illustrates further possible steps comprising a method for controlling an optical amplifier according to the present invention. Once the ASE power level has been determined, the amount of power emanating from the optical amplifier may also be determined (step 25). Typically, the power emanating from the optical amplifier comprises at least two components; an amplified rendition of the optical signal received by the amplifier system and a noise component, i.e. ASE.

In order to determine the amount of power in the output of the optical amplifier that is attributable to the amplified input signal (step 30), the method of the present invention provides for subtracting the a power level indicator of the amplified spontaneous emissions from an indicator of output power emanating from the optical amplifier. Generally, controlling the amount of energy that is imparted to an optical amplifier may control the gain of the optical amplifier. Hence, the method of the present invention provides for generating a drive signal (step 35) by comparing the difference between the power level of the amplified optical signal and the power level of the input optical signal. This drive signal may then be used as a basis for imparting an amount of energy to the optical amplifier (step 40). In one variation of this method, optical energy is directed into the optical amplifier

In operation, the method of the present invention provides for at least one means of determining the power level of the input optical signal. One such method provides that the optical signal arriving at an amplifier system by way of an input optical pathway may be segregated in order to capture a measurement portion of the optical signal. This measurement portion of the optical signal may then be used to generate a signal that is indicative of the power level of the incoming optical signal.

According to one possible variation of the method of the present invention, the amount of power output from the optical amplifier that is attributable to amplified spontaneous emissions may be determined. This may be accomplished empirically. Since the method of the present invention may be applied to a variety of optical amplifier technologies, one variation of the present method acknowledges that the amount of amplified spontaneous emissions from a particular amplifier design may be relatively constant. In such case, this illustrative method provides for the selection of an a priori value for a power level for the amplified spontaneous emissions that may be emitted by a particular type of amplifier. A signal reflecting this a priori value may then be generated.

Yet another example derivative of the method of the present invention may be applicable when controlling optical amplifiers that generate amplified spontaneous emissions essentially according to a particular function. In some cases, this function is determined empirically by observing the amount of ASE generated by a particular type of optical amplifier as different operating parameters are varied. Analytical methods for determining the ASE function may also be utilized.

One factor that dictates the amount of ASE generated by an optical amplifier is the amount of energy that is imparted to the amplifier. Accordingly, one derivative method of the present invention may determine the amount of energy that is delivered to an optical amplifier and then consult an ASE function in order to determine the amount of ASE that may be generated. As an example, the amount of optical energy that is delivered to the optical amplifier may be used as an independent variable to the ASE function. Other factors may also influence the amount of ASE generated by an optical amplifier including, but not limited to, input power, temperature and aging of the fiber optic segment comprising the optical amplifier. These, and other factors may be used by the method of the present invention as independent variables when consulting the ASE function in order to determine the amount of ASE that the optical amplifier is anticipated to generate in any given operating circumstance.

According to yet another illustrative variation of the present method, the amount of ASE generated by a particular type of optical amplifier may be measured. Sometimes, optical amplifiers may exhibit unpredictable ASE levels. In such cases, it may be necessary to measure the amount of ASE generated by the optical amplifier. This may be done by segregating some or all of the optical energy emitted by an input of the optical amplifier back into the input optical pathway that is used to direct an input optical signal to the amplifier. A signal indicative of the power level of this optical energy may be generated; essentially resulting in a direct indication of the amount of ASE generated by the optical amplifier.

Because the method of the present invention provides for controlling the gain of an optical amplifier, it may be necessary to determine the power level of an input optical signal. This power level indicator may then be used by a control function as an input that may be compared with a feedback signal. According to at least one illustrative method of the present invention, this may be done by measuring the power level of the incoming optical signal. One possible method for doing so provides for segregated a measurement portion of the incoming optical signal away from the input optical pathway that may be used to carry the incoming optical signal to the optical amplifier proper. This measurement portion may then be used to generate a signal that reflects the power level of the measurement portion of optical energy. This signal may then be scaled in order to determine the actual power of the input optical signal as some multiple of the sampled measurement portion.

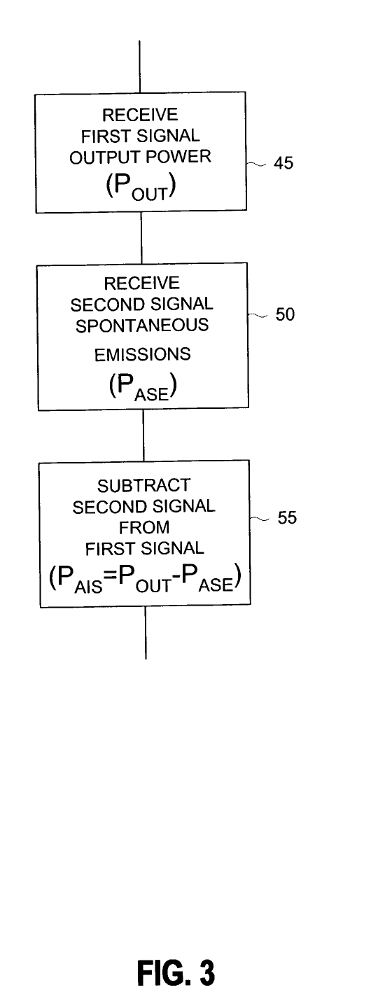

FIG. 3 is a flow diagram that depicts one possible method for determining the power of an amplified input signal in the output of an optical amplifier according to the present invention. In order to enhance the dynamic range of a control function that may be used to control an optical amplifier, one illustrative method of the present invention provides for generating an output power level signal that is indicative of the power level of an amplified optical signal emanating from the output of an optical amplifier. According to this illustrative method, the total power that emanates from the optical amplifier may comprise at least two components; the amplified optical input signal and an ASE noise component. By receiving a first signal (step 45) indicative of the power level of the output of the optical amplifier P_{OUT} and then receiving a second signal (step 50) indicative of the power level of the amplified spontaneous emissions P_{ASE}, the power level of the amplified optical signal may be reflected by a feedback signal that may be generated by subtracting (step 55) the second signal (P_{ASE}) from the first signal (P_{OUT}). This results in a signal indicative of the power of the amplified input optical signal P_{AIS}.

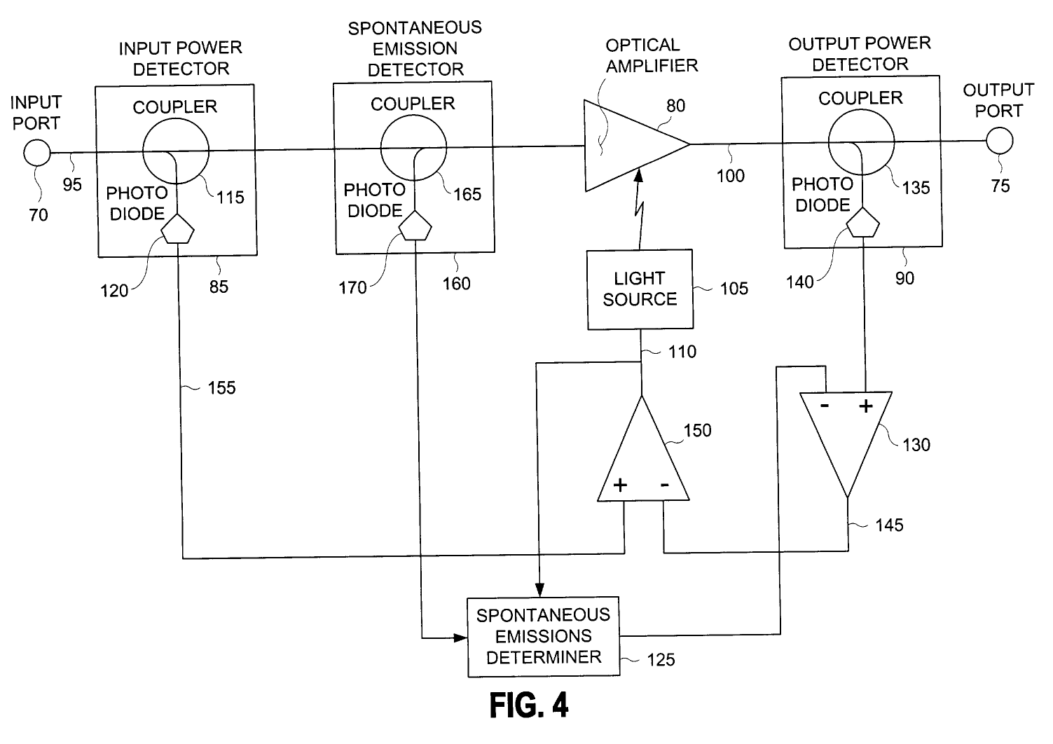

FIG. 4 is a block diagram that depicts one example structure of an optical amplifier system comprising spontaneous emissions cancellation according to the present invention. According to this illustrative embodiment, an optical amplifier system may comprise an input port 70 and an output port 75. Disposed between the input port 70 and the output port 75, the optical amplifier system typically comprises an optical amplifier 80.

In this illustrative embodiment, the amplifier system further comprises an input power detector 85 and an output power detector 90. Generally, an input optical pathway 95 may propagate an input optical signal that may be received by the input port 70 through to the optical amplifier 80. The input power detector 85 may be introduced in this path. The output of the optical amplifier 80 may be propagated by way of an output optical pathway 100 to the output port 75. The output power detector 90 may be disposed between the output of the optical amplifier 80 and the output port 75.

The present invention may further comprise an energy source for imparting energy to the optical amplifier 80 according to a control signal. One example of an energy source is a light source 105 for pumping the optical amplifier in order to induce stimulated emission amplification of an input optical signal that may be presented to the input of the optical amplifier 80. According to one alternative embodiment of the present invention, the light source may be a laser. The light source 105 is typically driven by an amplifier drive signal 110.

In operation, the amplifier system of the present invention may determine the power level of an input signal arriving at the input port 70 by way of the input power detector 85. According to one example embodiment of the present invention, the input power detector 85 may comprise an optical coupler 115 that may be used to siphon a measurement portion of optical energy from the input optical pathway 95. This measurement portion of optical energy may then be directed to an optical detector 120 that may further comprise the input power detector 85. The optical detector 120 may be a photodiode. The optical coupler 115 is disposed so as to segregate energy traversing the optical pathway 95 from the input port 70 to the optical amplifier 80.

According to one alternative embodiment of the present invention, the output detector 90 may comprise an optical coupler 135. The optical coupler 135 may be used to segregate a measurement portion of the optical power emanating from the optical amplifier 80. The measurement portion of the optical power may then be directed to a detector 140 further comprising the output detector 90. This detector may also be a photodiode. In operation, the optical energy emanating from the optical amplifier 80 may contain at least two components; an amplified rendition of the input optical signal arriving at the input of the optical amplifier 80 by way of the input optical pathway 95 and a noise component, i.e. amplified stimulated emissions. Hence, the signal that is generated according to the measurement portion of optical power received by the detector from the optical amplifier 80 typically comprises a composite output power indication.

The optical amplifier system of the present invention may further comprise a spontaneous emissions determiner 125. A first differencing unit 130 further comprising the invention may receive a composite power signal from the detector 140 comprising the output power detector 90. The first differencing unit 130 also receives a signal from the spontaneous emissions determiner 125 indicative of the amount of amplified spontaneous emission generated by the optical amplifier 80. The output of the first differencing unit 130 comprises a signal that is essentially an indication of the amount of power present in the total output power emanating from the optical amplifier 80 that is attributable to the amplified input optical signal. This signal may then be used as a controller feedback signal 145 to control the gain of the optical amplifier 80. Ideally, this feedback signal is essentially devoid of any ASE noise components.

According to this embodiment of the present invention, a second differencing unit 150 comprising the invention may receive the feedback signal 145 from the first differencing unit 130. The feedback signal 145 may then be compared with the input power as indicated by an input power signal 155 provided by the input power detector 85. The second differencing unit 150 typically generates an amplifier drive signal 110 that may be used to control the application of energy to the optical amplifier. This results in a closed feedback loop control of optical amplifier gain. According to one alternative embodiment, energy may be imparted to the optical amplifier 80 by a light source 105 that may further comprise the invention.

The amplifier system of the present invention may utilize different types of optical amplifiers 80 in order to amplify an optical signal received by way of the input port 70. According to one alternative embodiment of the present invention, the optical amplifier 80 may comprise an EDFA. Other various optical amplifiers may also be utilized.

Since different types of optical amplifiers exhibit differing spontaneous emission profiles, the amplifier system of the present invention may comprise various forms of a spontaneous emissions determiner 125. According to one illustrative embodiment of the present invention, the spontaneous emissions determiner 125 may provide an essentially constant reference that may represent an essentially constant value of spontaneous emissions generated by the optical amplifier 80.

In yet another illustrative embodiment of the present invention, the optical amplifier system may further comprise a spontaneous emissions detector 160. The spontaneous emissions detector 160 may itself comprise an optical coupler 165 and a detector 170. In some embodiments, the detector may comprise a photodiode. Generally, the optical coupler 165 comprising the spontaneous emissions detector 160 may be introduced into the input optical pathway 95 and is oriented such that it is capable of segregating all or some portion of the optical power emanating from the input of the optical amplifier 80 and is present in the input optical pathway 95. Hence, the detector 170 receiving such segregated optical power may generate a signal indicative of the amplified spontaneous emissions generated by the optical amplifier 80. The spontaneous emissions determiner 125 may receive the spontaneous emissions signal generated by the spontaneous emissions detector 160 and direct this signal to the first differencing unit 130 as described above.

According to yet another alternative embodiment of the present invention, the spontaneous emissions determiner 125 may comprise an input for receiving a signal representing an independent variable. The independent variable signal may represent the amount of energy delivered to the optical amplifier, the operating temperature of the optical amplifier or some other operating parameter that may affect the amplifier's ASE generation profile. The spontaneous emissions determiner may comprise a circuit that transforms the input signal into an ASE power level signal that represents the amount of ASE generated by the optical amplifier. In some cases, such a circuit may apply a slope correction to the input signal. In other cases, the transformation circuit may apply a step function to the input signal. The scope of the present invention is intended to include all forms of transformation circuitry that render an ASE profile from a particular independent variable input signal.

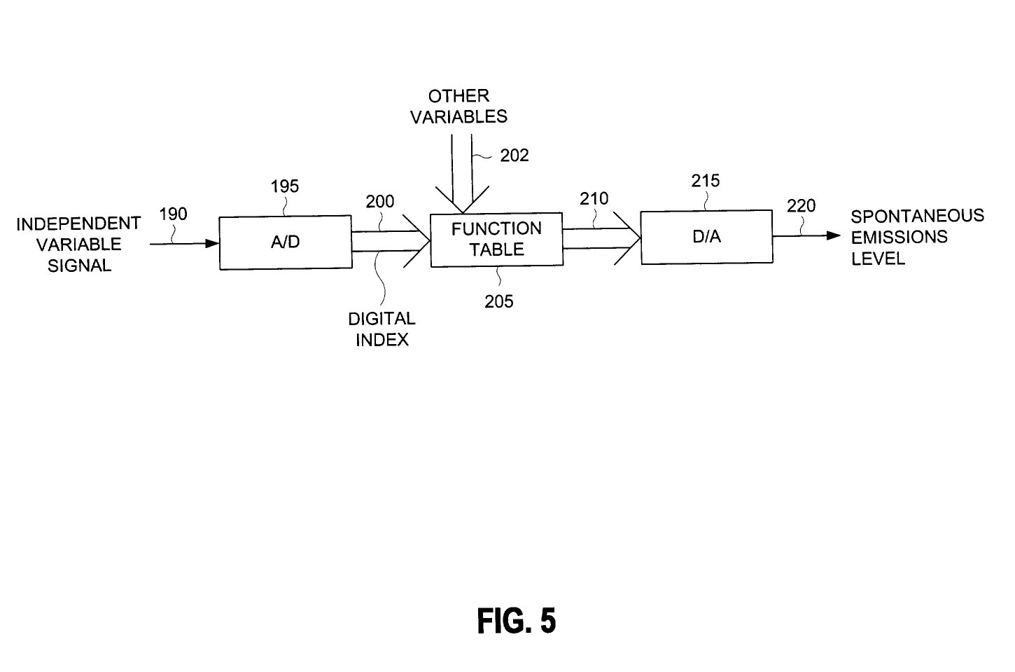

FIG. 5 is a block diagram of one possible alternative structure of a spontaneous emissions determiner that may be used to generate a spontaneous amplifier emissions signal according to the present invention. In one alternative embodiment of the invention, the spontaneous emissions determiner may be embodied by a function table 205. The output of the function table 210 may comprise a digital value indicative of the amount of spontaneous emissions the optical amplifier 80 will generate under a particular operating circumstance represented by an independent variable signal. In some embodiments, an indexing unit further comprises the invention and may be used to generate an index for accessing the function table 205. Where the input signal representing an independent variable is in analog form, the indexing unit may comprise an analog-to-digital converter 195. It should be noted that the function table 205 may be used to store an ASE function that provides estimated spontaneous emissions based on an independent operating parameter variable. One example of an independent variable that may be used to index the function table 205 is the amount of energy delivered to the optical amplifier 80. This may be in the form of optical energy delivered by a light source 105.

The function table 205 may further comprise additional inputs 202 for accepting other factors that may affect the amount of ASE that the optical amplifier may generate. Some additional factors that may be received by the function table of the present embodiment include, but are not necessarily limited to temperature, input power and age of a fiber optic segment that may comprise an optical amplifier comprising the optical amplifier system. The output 210 of the function table 205 may then be used to drive a digital-to-analog converter 215 that may then generate a signal 220 corresponding to the level of spontaneous emissions that the optical amplifier 80 comprising the present invention may generate. In cases where other independent variables are in analog form, the present invention may comprise additional analog-to-digital conversions for converting other signals into indices that may be used to index the function table 205.

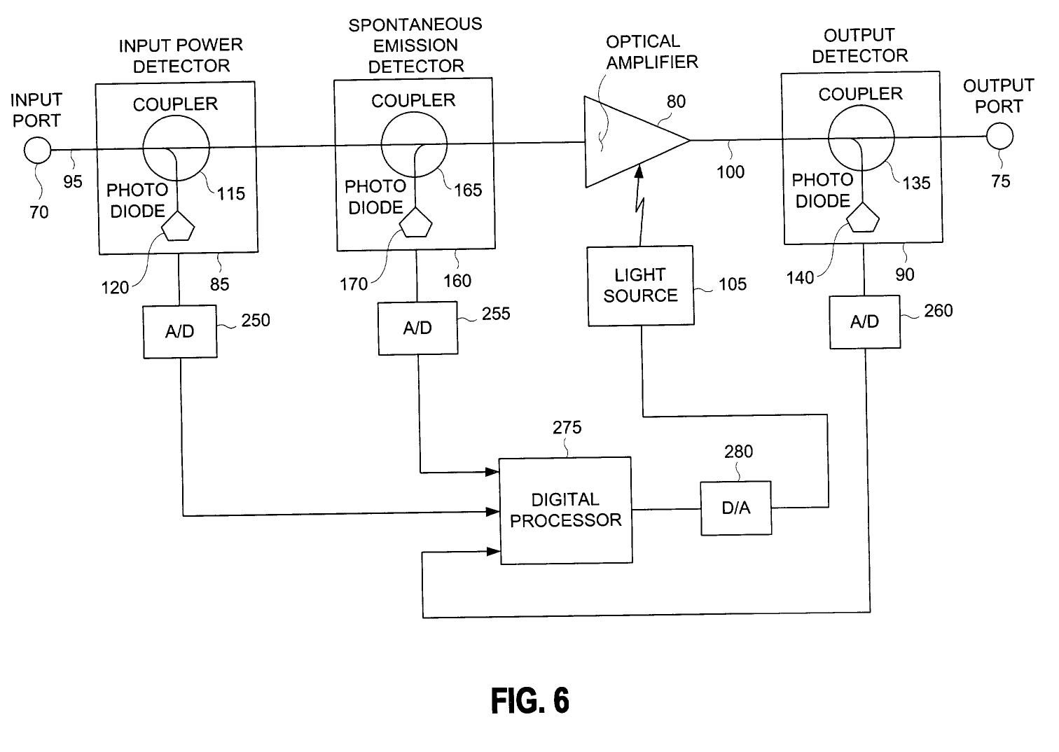

FIG. 6 is a block diagram of an illustrative optical amplifier system according to the present invention that is digitally controlled. Much akin to the previous embodiments henceforth described, the present invention may comprise an input power detector 85, optical amplifier 80, output power detector 90 and an energy source that in some example embodiments is a light source 105. This embodiment of the present invention may optionally comprise a spontaneous emissions detector 160.

According to this alternative embodiment of the present invention, a first digitizing unit 250 (analog-to-digital converter) may receive a signal indicative of the power of an input optical signal that may arrive at the input port 70. The first digitizing unit 250 may then generate a stream of digital values according to the input power signal. This first stream of digital values may then be directed to a digital processor 275 further comprising the invention.

According to this illustrative example of the invention, the output power detector 90 may deliver a signal indicative of the total power emanating from the optical amplifier 80. This signal may be conveyed to a second digitizing unit 260. The second digitizing unit 260 may then generate a second stream of digital values representing output power. This second stream is also directed to the digital processor 275.

According to one alternative embodiment of the present invention, a spontaneous emissions detector 160 may be inserted in an optical signal path from the input port 70 to the optical amplifier 80. Typically, the spontaneous emissions detector 160 will generate a signal according to the amount of amplified spontaneous emissions power emanating from an input of the optical amplifier 80. Yet a third digitizing unit 255 may convert the signal provided by the spontaneous emissions detector 160 into a stream of digital values that may then be directed to the digital processor 275.

The digital processor 275 may comprise an execution unit and program memory. According to one alternative embodiment of the present invention, a spontaneous emissions determination instruction sequence further comprising the invention may be stored in the program memory. Also comprising the invention is a spontaneous emissions cancellation instruction sequence. This, too, is stored in the program memory. According to this example embodiment, a sampled control-loop instruction sequence comprising the invention may also be stored in the program memory.

According to this example embodiment, control of amplifier gain is accomplished digitally using well-known, sampled control theory techniques. One feature of the present invention is the execution of the spontaneous emissions cancellation instruction sequence by the execution unit. Generally, the spontaneous emissions cancellation instruction sequence receives a stream of digital values representative of the total power emanating from the output of the optical amplifier 80. This stream is typically received from the second digitizing unit 260. The spontaneous emissions cancellation instruction sequence may call the spontaneous emissions determination instruction sequence as a subroutine. The spontaneous emissions determination instruction sequence may return a value representative of the amount of amplified spontaneous emissions that may be generated by the optical amplifier 80. According to this example embodiment, the spontaneous emissions cancellation instruction sequence may then generate a feedback stream of digital values. A simple subtraction on a sample-by-sample basis of the value returned by the spontaneous emissions determination instruction sequence from the stream of digital values received from the second digitizing unit may yield the feedback stream.

The feedback stream generated by the spontaneous emissions cancellation instruction sequence is essentially devoid of any noise components such as amplified simulated emissions. This feedback stream may then be conveyed to a sampled control-loop instruction sequence. Minimally, the sampled control-loop instruction sequence causes the execution unit to receive the feedback stream and generate a stream of digital values for controlling the amount of energy that is delivered to the optical amplifier. In some embodiments of the present invention, energy is delivered to the optical amplifier 80 optically from a light source 105. The sampled control-loop instruction sequence generally applies sampled control theory to minimize the difference between the feedback data stream, appropriately factored, and the input power stream received from the first digitizing unit 250.

According to one alternative example embodiment of the present invention, the control stream of digital values may then be used to drive a digital-to-analog converter 280. The digital-to-analog converter 280 may then convert the stream of digital values into an analog control signal that may then be used to drive an energy source that further comprises the invention. A pump light source 105 may be driven in this manner. Accordingly, the digital-to-analog converter 280 and the pump light source 105 typically further comprise the invention. It should be further noted that the input power detector 85, the spontaneous emissions detector 160 (when such as spontaneous emissions detector comprises the invention) and the output power detector 90 may comprise optical couplers and detectors. The detectors may be photodiodes.

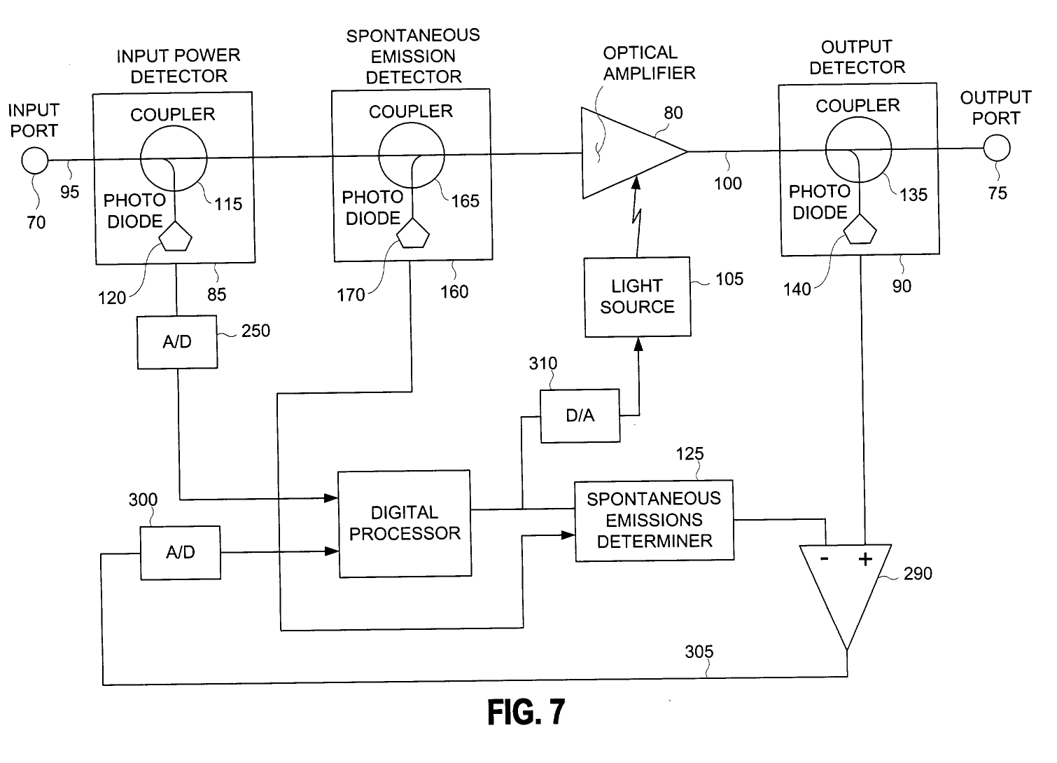

FIG. 7 is a block diagram of one example structure of an optical amplifier system comprising digital control and an analog spontaneous emissions cancellation circuit according to the present invention. According to one alternative embodiment of an amplifier system comprising digital control, the invention comprises a digital processor 275, input power detector 85, optical amplifier 80, a light source 105 and an output power detector 90. Further comprising the invention may be a spontaneous emissions determination circuit akin to that used in an analog controlled optical amplifier system described supra.

The spontaneous emissions determination circuit 125 may comprise a reference for generating a constant signal in those cases where the optical amplifier 80 is known to generate a constant level of amplified spontaneous emissions. In an alternative embodiment, the spontaneous emissions determination circuit 125 may generate a signal according to various operating parameters as already described. In one alternative embodiment, the spontaneous emissions determination circuit 125 may receive an amplifier drive signal 110 as an indication of the amount of energy that is delivered to the optical amplifier 80 and may use this to determine the level of amplified spontaneous emissions. Other independent variables, as already taught, may be used to drive an ASE function. It should be noted that the spontaneous emissions determination circuit 125 may receive the amplifier drive signal 110 as an analog signal that it may then convert to a digital value as described above. In yet another alternative embodiment, the present invention may further comprise a spontaneous emissions detector 160 that may generate a signal according to the power level of any amplified spontaneous emissions emanating from the input of the optical amplifier 80.

The ASE power level signal generated by the spontaneous emissions determiner 125 may be used by a first differencing unit 290, that may further comprise the invention, to remove ASE noise components from an output power signal that may be generated by the output power detector 90. Hence, the first differencing unit 290 typically generates a feedback signal substantially free of ASE noise components.

In order to effect digital control using sampled control theory techniques, this example embodiment further comprises a first digitizing unit 250 that generates a first stream of digital values according to the power level of the input optical signal arriving at the input port 70. A second digitizing unit 300 receives the feedback signal 305 generated by the first differencing unit 290 and generates a second stream of digital values comprising a feedback signal representative of the output power of an amplified input optical signal.

The digital processor 275, according to this example embodiment of the invention, may then apply sampled control theory well known in the art to generate a stream of digital values for controlling the amount of energy that must be applied to the optical amplifier 80 in order to maintain controlled amplifier gain. This stream of digital values may be converted into an amplifier drive signal 110 by a digital-to-analog converter 310 further comprising the invention. The amplifier drive signal 110 may then be used to drive an energy source. The energy source may be a light source 105.

Alternative Embodiments

While this invention has been described in terms of several preferred embodiments, it is contemplated that alternatives, modifications, permutations, and equivalents thereof will become apparent to those skilled in the art upon a reading of the specification and study of the drawings. It is therefore intended that the true spirit and scope of the present invention include all such alternatives, modifications, permutations, and equivalents.

What is claimed is:

1. A method for amplifying an optical signal comprising the steps of:
determining the power level of the optical signal;
amplifying the optical signal through an optical amplifier;
determining the power level of amplified spontaneous emissions emitted by the optical amplifier;
determining the power level of the output of the optical amplifier;
determining the power level of the amplified optical signal by subtracting the power level of amplified spontaneous emissions from the power level of the output of the optical amplifier; and
driving the optical amplifier with energy according to the difference between the power level of the amplified optical signal and the power level of the optical signal.

2. The method of claim 1 wherein the step of determining the power level of the optical signal comprises the steps of:
segregating a measurement portion of the optical signal; and
generating a signal indicative of the power level of the measurement portion of the optical signal.

3. The method of claim 1 wherein the step of determining the power level of amplified spontaneous emissions emitted by the optical amplifier comprises generating a substantially constant signal indicative of a power level value.

4. The method of claim 1 wherein the step of determining the power level of amplified spontaneous emissions emitted by the optical amplifier comprises the step of consulting a function to determine amplified spontaneous emissions power level.

5. The method of claim 4 further comprising the step of providing the amount of energy delivered to the optical amplifier to the function as an independent variable.

6. The method of claim 4 further comprising the step of providing the operating temperature of the optical amplifier to the function as an independent variable.

7. The method of claim 1 wherein the step of determining the power level of amplified spontaneous emissions emitted by the optical amplifier comprises the step of generating a signal indicative of the amount of amplified spontaneous emissions according to the amount of energy delivered to the optical amplifier.

8. The method of claim 1 wherein the step of determining the power level of amplified spontaneous emissions emitted by the optical amplifier comprises the steps of:
segregating all or a portion of the optical energy emanating from an input of the optical amplifier; and
generating a signal indicative of the power level of said optical energy.

9. The method of claim 1 wherein the step of determining the power level of the output of the optical amplifier comprises the steps of:
segregating a measurement portion of optical energy from the output of the optical amplifier; and
generating a signal indicative of the power level of said measurement portion.

10. The method of claim 1 wherein the step of determining the power level of the amplified optical signal comprises the steps of:
receiving a first signal indicative of the power level of the output of the optical amplifier;
receiving a second signal indicative of the power level of the amplified spontaneous emissions; and
generating a signal indicative of the power level of the amplified optical signal by subtracting the second signal from the first signal.

11. The method of claim 1 wherein the step of driving the optical amplifier with energy comprise the steps of:
generating an amplifier drive signal that results in a minimized difference between an amplified optical signal power signal and an input signal power signal;
producing pump light according to the amplifier drive signal; and
imparting the pump light to the optical amplifier.

12. An optical amplifier system comprising:
input power detector unit that generates an input power signal;
optical amplifier element that amplifies the optical signal according to the amount of energy it receives;
spontaneous emissions determination unit that generates a spontaneous emissions signal;
output power detector unit that generates an output power signal;
first differencing unit that generates an amplifier feedback signal by subtracting the spontaneous emissions signal from the output power signal;
second differencing unit that generates an amplifier drive signal by subtracting the amplifier feedback signal from the input power signal; and
optical amplifier drive unit that provides energy to the optical amplifier element according to the amplifier drive signal.

13. The optical amplifier system of claim 12 wherein the input power detector unit comprises:
optical coupler that segregates a measurement portion of the optical signal; and
detector that converts the measurement portion of the optical signal received from the optical coupler into a signal.

14. The optical amplifier system of claim 12 wherein the spontaneous emissions determination unit comprises a reference source that generates a substantially constant signal.

15. The optical amplifier system of claim 12 wherein the spontaneous emissions determination unit generates a signal indicative of the amount of spontaneous emissions generated by an optical amplifier element according to an input signal.

16. The optical amplifier system of claim 15 wherein the spontaneous emissions determination unit receives an input signal indicative of the amount of energy imparted to the optical amplifier element.

17. The optical amplifier system of claim 15 wherein the spontaneous emissions determination unit receives an input signal indicative of the operating temperature of the optical amplifier element.

18. The optical amplifier system of claim 12 wherein the spontaneous emissions determination unit comprises:
reference table that stores values for amplified spontaneous emissions;
table index unit that generates an index for the reference table; and
signal generator that generates a signal according to a reference value provided by the indexed reference table.

19. The optical amplifier system of claim 18 wherein the table index unit comprises an analog-to-digital converter that receives an analog amplifier drive signal and generates a digital index value.

20. The optical amplifier system of claim 18 wherein the signal generator comprises a digital-to-analog converter that generates an analog signal according to a digital value it receives from the reference table.

21. The optical amplifier system of claim 12 wherein the spontaneous emissions determination unit comprises:
optical coupler that segregates all or a portion of the optical energy emitted by the input of the optical amplifier element; and
detector that converts the optical energy received from the optical coupler into a signal.

22. The optical amplifier system of claim 12 wherein the output power detector unit comprises:
coupler that segregates a measurement portion of optical power emitted by the output of the optical amplifier element; and
detector that converts the measurement portion of optical power received from the optical coupler into a signal;

23. The optical amplifier system of claim 12 wherein the first differencing unit comprises an instrumentation amplifier that subtracts the spontaneous emissions signal from the output power signal.

24. The optical amplifier system of claim 12 wherein the optical amplifier drive unit comprises a pump light source that imparts light to the optical amplifier element according to the amplifier drive signal.

25. An optical amplifier system comprising:
input power detector unit that generates an input power signal;
optical amplifier element that amplifies the optical signal according to the amount of energy it receives;
output power detector unit that generates an output power signal;
first digitizing unit that converts the input power signal into a stream of digital values;
second digitizing unit that converts the output power signal into a stream of digital values;
processing unit comprising:
execution unit;
program memory;
spontaneous emissions determination instruction sequence stored in program memory;
spontaneous emissions cancellation instruction sequence stored in program memory; and
sampled control loop instruction sequence stored in program memory
wherein the execution unit:
executes the spontaneous emissions cancellation instruction sequence that minimally causes the execution unit to:
receive the stream of digital values from the second digitizing unit;
execute and receive from the spontaneous emissions determination instruction sequence a value for amplified spontaneous emissions;
generate a feedback stream of digital values by subtracting the value for amplified spontaneous emissions from each corresponding digital value comprising the stream of digital values received from the second digitizing unit;
execute the sampled control loop instruction sequence that minimally causes the processor to:
receive the feedback stream of digital values;
receive the stream of digital values from the first digitizing unit;
generate a control stream of digital values according to a sampled control loop function that uses the stream of digital values received from the first digitizing unit as a control reference for the feedback stream of digital values;
digital-to-analog converter that converts the control stream of digital values into an amplifier drive signal; and
amplifier drive unit that provides energy to the optical amplifier element according to the amplifier drive signal.

26. The optical amplifier system of claim 25 wherein the input power detector comprises:
optical coupler that segregates a measurement portion of the optical signal received by the input port; and
detector that converts the measurement portion of the optical signal received from the optical coupler into an electrical signal.

27. The optical amplifier system of claim 25 wherein the spontaneous emissions determination instruction sequence returns a constant value when it is executed.

28. The optical amplifier system of claim 25 further comprising a function stored in the program memory and wherein the spontaneous emissions determination instruction sequence returns a value by consulting the function.

29. The optical amplifier system of claim 25 further comprising:
spontaneous emissions power detector that generates a spontaneous emissions signal according to the power of the spontaneous emissions emanating from an input of the optical amplifier element; and
third analog-to-digital converter generates a stream of digital values according to the spontaneous emissions signal and wherein the spontaneous emissions determination instruction sequence returns a value according to the stream of digital values generated by the third analog-to-digital converter.
